(19) United States
(12) Patent Application Publication
(10) Pub. No.: US 2026/0128908 A1
(43) Pub. Date: May 7, 2026

(54) CLOSED-LOOP GOVERNANCE FOR DIGITAL TWINS

(71) Applicant: George William Bickerstaff, III, Greenwich, CT (US)

(72) Inventor: George William Bickerstaff, III, Greenwich, CT (US)

(21) Appl. No.: 19/438,620

(22) Filed: Jan. 1, 2026

(51) Int. Cl. H04L 9/32

(52) U.S. Cl. CPC H04L 9/3247

(57) ABSTRACT

A closed-loop governance system enforces identity-and policy-based constraints within trusted execution environments prior to execution or state transition. Governance confidence is computed using hardware-constrained inference, and execution is suppressed unless approval is cryptographically proven. The system enables verifiable governance across distributed digital twin environments.

### FIELD OF THE INVENTION

The present invention relates to governance enforcement in computational systems. More particularly, the invention relates to hardware-anchored systems and methods for evaluating and enforcing identity-, policy-, and context-based constraints prior to execution or state transition.

The invention is applicable to digital twins, autonomous systems, cloud platforms, and regulated computing environments.

### BACKGROUND OF THE INVENTION

Digital twins and autonomous computational systems increasingly perform actions that affect physical assets, financial processes, safety-critical operations, and regulatory obligations. In many existing systems, governance decisions such as authorization, identity validation, or policy compliance are evaluated after execution has begun or after outputs are produced. This separation between governance evaluation and execution introduces risks including bypass, replay, stale authorization, and inconsistent enforcement across distributed environments.

Software-based governance mechanisms are typically implemented outside of execution boundaries and may be circumvented by compromised components, asynchronous execution paths, or downstream processing. Trusted execution environments provide hardware-backed isolation and integrity but are commonly used only to protect sensitive data rather than to enforce governance decisions as mandatory preconditions to execution.

Accordingly, there exists a need for a governance system that enforces decisions prior to execution in a verifiable, portable, and hardware-anchored manner.

### SUMMARY OF THE INVENTION

The invention provides a closed-loop governance system in which governance decisions are evaluated and enforced within a trusted execution environment prior to execution, persistence, or release of outputs. Governance confidence is computed using hardware-constrained machine-learning inference operating inside the trusted execution environment. Execution is suppressed unless governance criteria are satisfied and cryptographically proven.

Upon successful governance evaluation, a cryptographically signed clearance token is generated within the trusted execution environment and bound to the governed output. The clearance token enables downstream systems to verify that governance enforcement occurred prior to execution. The system supports verification across heterogeneous execution environments while maintaining isolation of sensitive data.

### DEFINITIONS

Action: An operation, computation, execution step, or state transition requested to be performed by a governed system.
Actor: Any human user, software process, service, device, or autonomous system that initiates an action.
Actor Classification: A categorization of an actor based on identity, behavioral, or contextual signals.
Append-Only Audit Structure: A data structure in which records are written sequentially and are not modified or deleted.
Attestation: A signal or evidence used to evaluate identity, integrity, behavior, or context.
Attestation Fusion: The process of combining multiple attestations into a unified representation for governance evaluation.
Clearance Token: A cryptographically signed artifact generated within a trusted execution environment indicating governance approval.
Closed-Loop Governance: A governance model in which evaluation, enforcement, and verification occur as a continuous cycle prior to execution.
Context: Environmental, temporal, operational, or situational information relevant to governance evaluation.
Context-Aware Decay: A reduction in governance confidence over time based on context or policy.
Cross-Platform Verification: Validation of governance proof across heterogeneous execution environments.
Cross-Hardware Attestation Bridge: A mechanism enabling verification of clearance tokens across different trusted execution environments.
Digital Twin: A computational representation of a physical, logical, or organizational system.
Execution: Performance of an action that may consume resources or modify system state.
Execution Boundary: A point at which execution, state mutation, or output release may occur.
Feature Extraction: Derivation of measurable characteristics from attestations or signals.
Governance Confidence State: A computational object representing evaluated compliance with governance requirements.
Governance Engine: A component that evaluates governance confidence states within a trusted execution environment.
Governed Output: Any output produced by a system that is subject to governance enforcement.
Hardware-Constrained Machine-Learning Inference: Machine-learning inference executed within hardware or enclave memory limits.
Policy: A set of rules or thresholds defining acceptable conditions for execution.
Policy Adaptation: Dynamic adjustment of policy thresholds based on context or classification.
Pre-State Transition Boundary: A control point at which execution is blocked unless governance approval is granted.
Pre-State Transition Suppression: Prevention of execution prior to state mutation or output release.
Trusted Execution Environment (TEE): A hardware-backed or isolated execution environment protecting code and data.
Verification: Confirmation of authenticity, integrity, and scope of a clearance token.

### DETAILED DESCRIPTION OF THE INVENTION

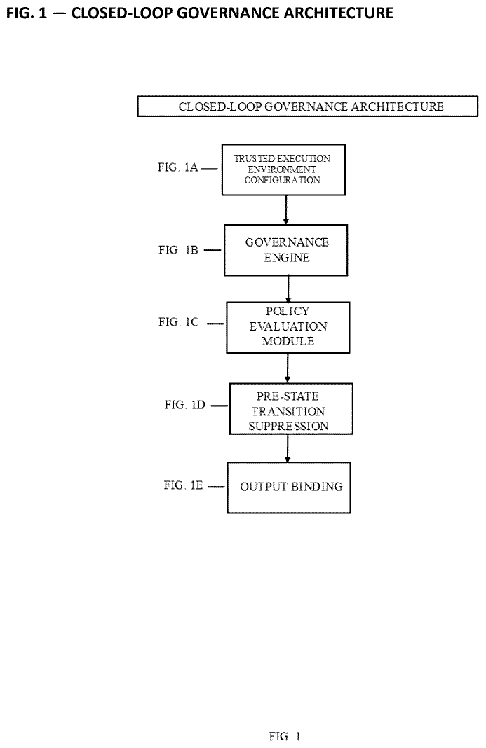

### FIG. 1—CLOSED-LOOP GOVERNANCE ARCHITECTURE

FIG. 1 illustrates an overall system architecture for closed-loop governance. Governance evaluation occurs before execution or state transition. Outputs are released only after cryptographic proof of governance approval.

FIG. 1A illustrates a trusted execution environment configuration. Governance logic, cryptographic material, and inference components are isolated from the host system. External access to protected components is prevented.

FIG. 1B illustrates a governance engine executing within the trusted execution environment. The engine computes a governance confidence state from fused attestations. This computation precedes any execution.

FIG. 1C illustrates a policy evaluation module. Governance confidence states are compared against defined thresholds. Evaluation results determine whether execution is permitted.

FIG. 1D illustrates pre-state transition suppression. Execution is blocked before state mutation or output release when criteria are not satisfied. Suppression prevents downstream bypass.

FIG. 1E illustrates output binding. A clearance token is cryptographically bound to the governed output. Outputs lacking valid binding are rejected.

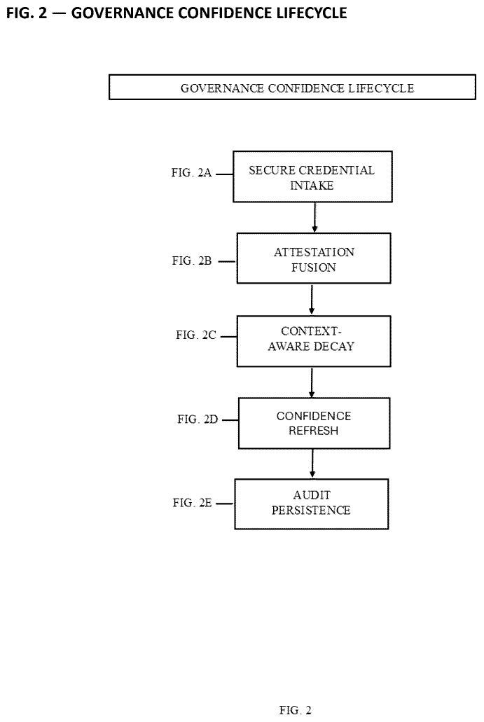

### FIG. 2—GOVERNANCE CONFIDENCE LIFECYCLE

FIG. 2 illustrates the lifecycle of a governance confidence state. The lifecycle includes creation, decay, refresh, and persistence. All stages occur within the trusted execution environment.

FIG. 2A illustrates attestation intake. Identity and contextual signals are received and validated. Invalid inputs are rejected.

FIG. 2B illustrates attestation fusion. Validated signals are combined using hardware-constrained inference. A compact governance confidence state is produced.

FIG. 2C illustrates context-aware decay. Confidence decreases over time based on policy and context. This prevents reuse of stale approvals.

FIG. 2D illustrates confidence refresh. New attestations update confidence without modifying prior records. Refresh events are traceable.

FIG. 2E illustrates audit persistence. Governance artifacts are stored in append-only form. Sensitive data is not disclosed.

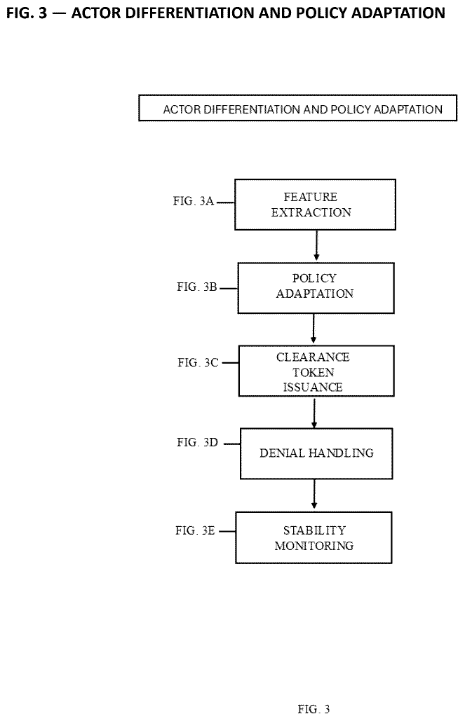

### FIG. 3—ACTOR DIFFERENTIATION AND POLICY ADAPTATION

FIG. 3 illustrates actor differentiation and policy adaptation. Actor behavior and context influence governance strictness. Classification informs policy thresholds.

FIG. 3A illustrates feature extraction. Features are derived from attestations within the trusted execution environment. Extracted features are protected.

FIG. 3B illustrates policy adaptation. Policy thresholds adjust dynamically based on classification and context. Adjustments occur prior to execution.

FIG. 3C illustrates clearance token issuance. A cryptographically signed token is generated upon approval. The token is scoped to the action.

FIG. 3D illustrates denial handling. Execution is suppressed when governance fails. Denials are recorded.

FIG. 3E illustrates stability monitoring. Governance confidence is monitored over time. Anomalies may trigger re-evaluation.

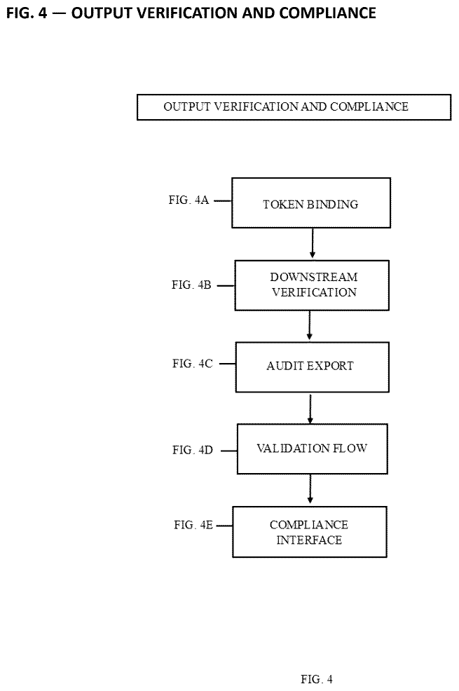

### FIG. 4—OUTPUT VERIFICATION AND COMPLIANCE

FIG. 4 illustrates downstream verification of governed outputs. Verification ensures approval occurred prior to execution. Outputs without proof are rejected.

FIG. 4A illustrates token binding. Clearance tokens are bound to outputs. Binding prevents tampering.

FIG. 4B illustrates downstream verification. Verifiers confirm authenticity and scope. Invalid tokens result in rejection.

FIG. 4C illustrates audit export. Governance proofs are exported for review. Sensitive data remains protected.

FIG. 4D illustrates a validation flow. Each validation step must succeed. Failure halts acceptance.

FIG. 4E illustrates a compliance interface. Auditors review proofs without system access. Verification is simplified.

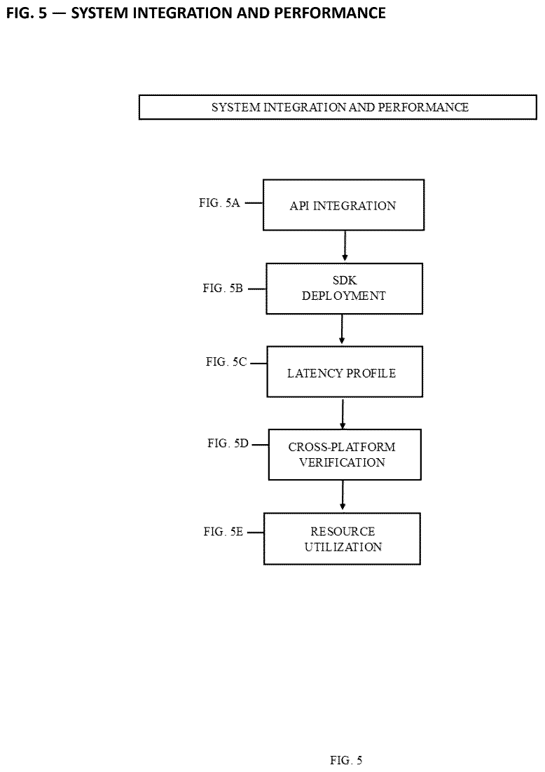

### FIG. 5—SYSTEM INTEGRATION AND PERFORMANCE

FIG. 5 illustrates system integration across heterogeneous environments. Governance enforcement is consistent. Performance characteristics are preserved.

FIG. 5A illustrates API integration. Standardized interfaces invoke governance enforcement. Integration does not bypass evaluation.

FIG. 5B illustrates sdk deployment. Developer tooling simplifies integration. Enforcement behavior remains consistent.

FIG. 5C illustrates latency characteristics. Governance evaluation occurs prior to execution. Hardware acceleration reduces delay.

FIG. 5D illustrates cross-platform verification. Clearance tokens remain verifiable across environments. Governance enforcement is portable.

FIG. 5E illustrates resource utilization. Pre-state suppression prevents unnecessary computation. System efficiency is improved.

1. A closed-loop governance system comprising: a trusted execution environment; a governance engine executing within the trusted execution environment and configured to compute a governance confidence state using hardware-constrained machine-learning inference; a pre-state transition suppression mechanism configured to prevent execution unless the governance confidence state satisfies a policy; and a clearance token cryptographically generated within the trusted execution environment and bound to a governed output.

2. A method of closed-loop governance comprising: computing a governance confidence state within a trusted execution environment using hardware-constrained machine-learning inference; suppressing execution prior to a state transition when governance criteria are not satisfied; issuing a cryptographically signed clearance token upon satisfaction of the governance criteria; and binding the clearance token to an output for downstream verification.

3. A non-transitory computer-readable medium storing instructions that, when executed by one or more processors, cause the one or more processors to perform the method of claim 2.

4. The system of claim 1, wherein the governance engine performs attestation fusion using a plurality of identity, behavioral, and contextual signals.

5. The system of claim 1, wherein the governance confidence state is subject to context-aware decay over time.

6. The system of claim 1, wherein verification of the clearance token is supported across heterogeneous trusted execution environments.

7. The method of claim 2, further comprising recording governance artifacts in an append-only audit structure.
